(19) United States
(12) Patent Application Publication
(10) Pub. No.: US 2004/0045786 A1
(43) Pub. Date: Mar. 11, 2004

(54) Banknote receiving system used in a ticket vendor or the like

(76) Inventor: Cheng-Kang Yu, Taipei (TW)

Correspondence Address: RABIN & BERDO, P.C., Suite 500, 1101 14th STREET, N.W., Washington, DC, 20005, US

(21) Appl. No.: 10/234,389

(22) Filed: Sep. 5, 2002

(51) Int. Cl. G07F 7/04

(52) U.S. Cl. 194/206

(57) ABSTRACT

A banknote receiving system used in a ticket vender or the like to verify and collect inserted banknote, in which a press device is provided at one side of the banknote passage, having a springy suspension arm and a nylon impression block at the free end of the springy suspension arm for pressing inserted banknote on a magnetic induction head for positive verification.

### BACKGROUND OF THE INVENTION

1. Field of the Invention

The present invention relates to a banknote receiving system for use in a ticket vending machine, money exchange machine, or the like and, more particularly to such a banknote receiving system, which uses a press device with a springy suspension arm to positively secure inserted banknote to the magnetic induction head for verification without interfering the functioning of the magnetic induction head.

2. Description of the Related Art

A variety of ticket vending machines have been disclosed, and intensively used in parking lots, stations, public facilities for receiving banknote and vending tickets. A regular ticket vending machine comprises a banknote detector unit adapted to verify the authenticity of banknote inserted therein, and a banknote storage cabinet adapted to receive verified banknote transferred from the banknote receiving and verification unit. According to conventional designs, photoelectric transmitter and receiver modules are commonly used to detect the authenticity of inserted banknote. When banknote inserted through the banknote insertion slot to the transmission mechanism inside the system, the photoelectric transmitter emits light onto inserted banknote, and the photoelectric receiver receives reflected light from inserted banknote and outputs a corresponding induction current for verifying the authenticity of detected banknote. Further, the banknote receiving system has a pivoted metal press member adapted to hold inserted banknote for verification. The metal press member may affect the production of induction current of the photoelectric receiver.

### SUMMARY OF THE INVENTION

The present invention has been accomplished to provide a banknote receiving system, which eliminates the aforesaid drawbacks. It is the main object of the present invention to provide a banknote receiving system, which presses inserted banknote on the magnetic induction head for accurate verification. It is another object of the present invention to provide a banknote receiving system, which has a simple structure that achieves banknote verification accurately. According to one aspect of the present invention, the banknote receiving system comprises a housing, the housing having a banknote insertion slot, and a detector unit installed in the housing and adapted to verify the authenticity of banknote being inserted into the banknote insertion slot, wherein the detector unit comprises a first casing, and a second casing defining with the first casing a banknote passage for guiding inserted banknote from the banknote insertion slot to a banknote storage cabinet, the second casing comprising a magnetic induction head suspended at one side of the banknote passage and adapted to verify the authenticity of banknote passing through the banknote passage, the first casing comprising a press device adapted to press banknote passing through the banknote passage on the magnetic induction head, the press device comprising a mounting base, a springy suspension arm projected from the periphery of the mounting base and terminating in a free end, and an impression block located on one side of the free end and partially protruded over an outside wall of the first casing into the banknote passage and adapted to press banknote passing through the banknote passage on the magnetic induction head for verification.

### BRIEF DESCRIPTION OF THE DRAWINGS

FIG. 1 is an exploded view of a banknote receiving system according to the present invention.

FIG. 2 is an elevational assembly view of the banknote receiving system according to the present invention.

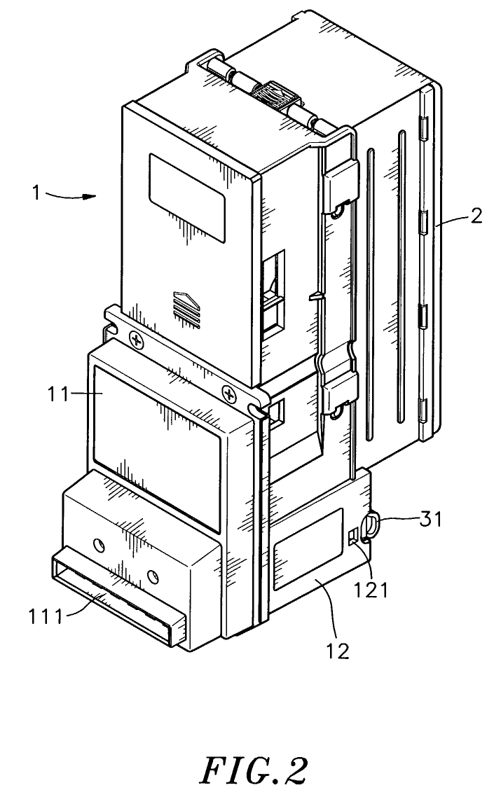

FIG. 3 is an exploded view of the first casing for the detection unit of the banknote receiving system according to the present invention.

FIG. 4 is an elevational view of the press device for the detection unit of the banknote receiving system according to the present invention.

FIG. 5 is a sectional side view of the detection unit for the banknote receiving system according to the present invention.

### DETAILED DESCRIPTION OF THE PREFERRED EMBODIMENT

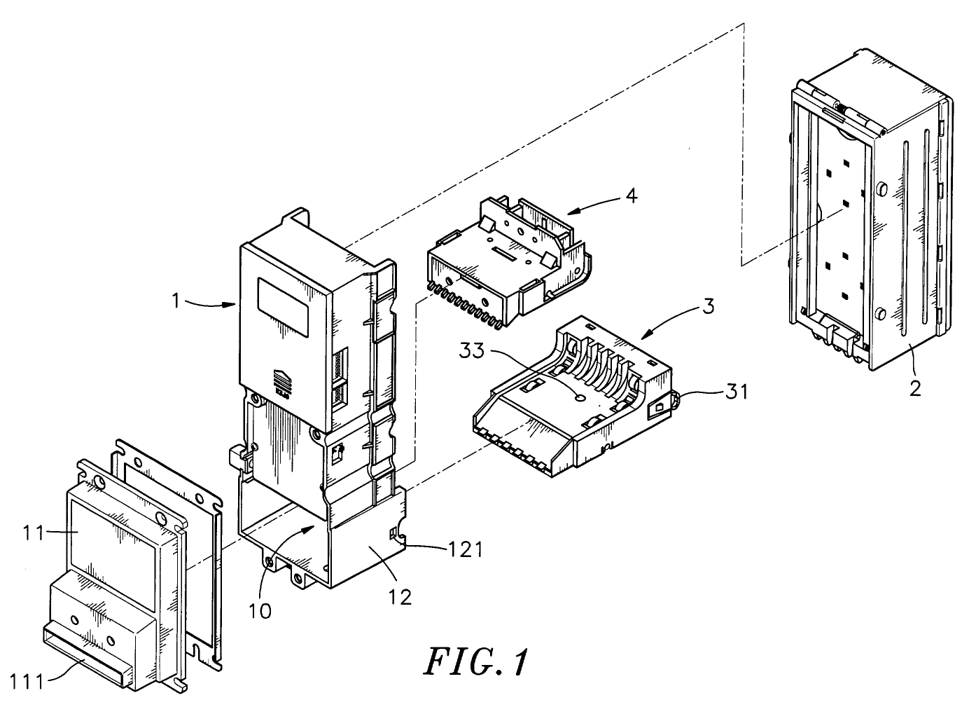

Referring to FIGS. 1˜4, a banknote receiving system is shown comprised of a housing 1, a banknote storage cabinet 2, and a detector unit formed of a first casing 3 and a second casing 4. The housing 1 has a face panel 11 defining a banknote insertion slot 111, a bottom receiving chamber 10 adapted to receive the detector unit. The two vertical side panels 12 of the bottom receiving chamber 10 each have a rear retaining notch 121. The first casing 3 and the second casing 4 defining a banknote passage for guiding a banknote from the banknote insertion slot 111 of the housing 1 toward the banknote storage cabinet 2. The detector unit is connected to the banknote insertion slot 111, and adapted to verify the authenticity of the inserted banknote for enabling the verified banknote to be delivered by the internal transmission mechanism of the housing 1 to the banknote storage cabinet 2.

The first casing 3 comprises a press device 32 provided on the inside, and two retaining members 31 bilaterally located on the rear side. When the first casing 3 inserted into the bottom receiving chamber 10 of the housing 1, the retaining members 31 are respectively forced into engagement with the retaining notches 121 of the housing 1 to secure the first casing 3 firmly to the housing 1.

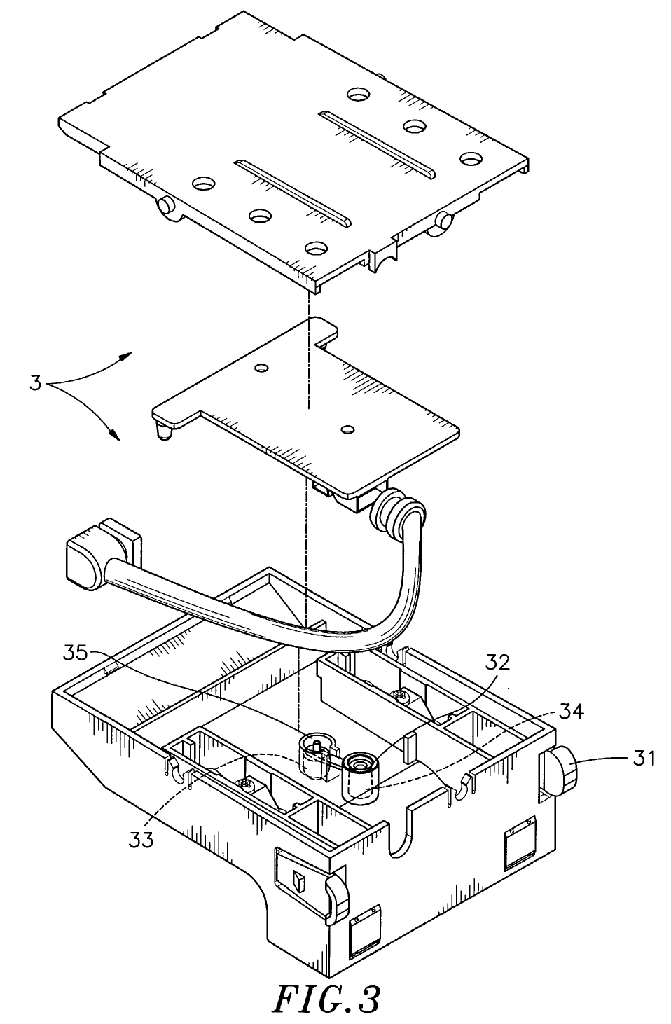

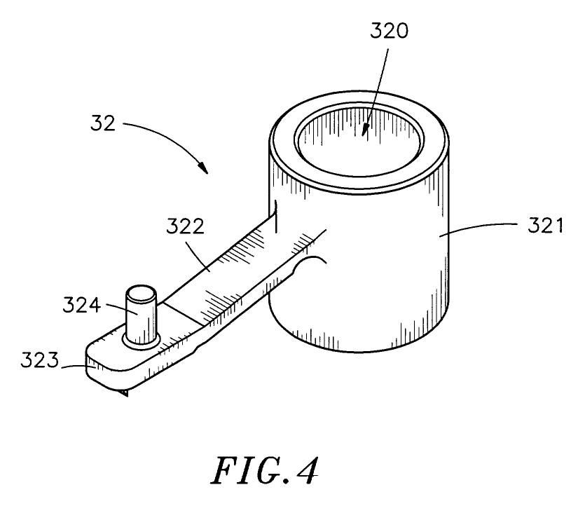

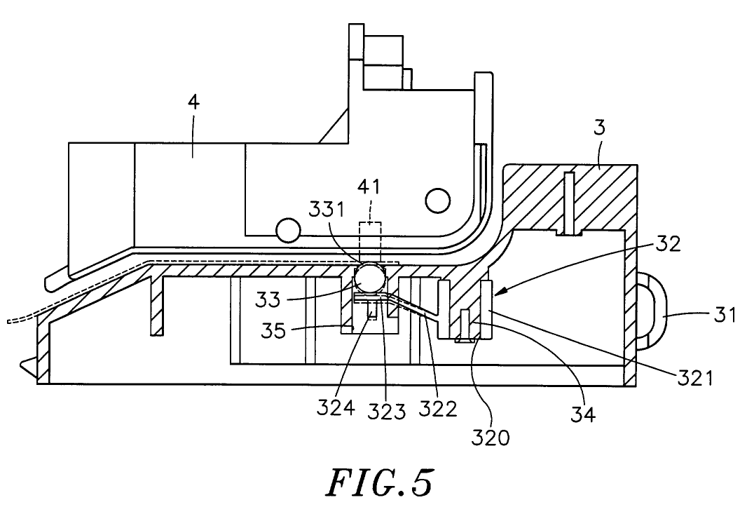

Referring to FIG. 5 and FIGS. 3 and 4 again, the press device 32 comprises a cylindrical base 321, a locating hole 320 extended through the top and bottom ends of the base 321, and a springy suspension arm 322 projected from the periphery of the base 321. An impression block 33 is provided at one side of the free end 323 of the springy suspension arm 322, and aimed at a magnetic induction head 41 of the second casing 4. The impression block 33 has a smoothly arched surface portion 331 protruded over the surface of the first casing 3 and forced by the spring power of the springy suspension arm 322 to press the passing banknote on the magnetic induction head 41. The other side of the free end 323 of the springy suspension arm 322 is provided with a stop rod 324 that limits the amount of vertical movement of the free end 323 of the springy suspension arm 322, preventing breaking of the suspension arm 322 due to excessive amount of motion relative to the base 321. The first casing 3 further comprises a mounting shaft 34 fitted into the locating hole 320 of the press device 32 to hold the press device 32 in place, and a receptacle 35 adapted to receive and guide vertical movement of the free end 323 of the springy suspension arm 322 and the impression block 33.

When a banknote inserted into the banknote insertion slot 111, the smoothly arched surface portion 331 of the press block 33 presses the inserted banknote against the magnetic induction head 41, enabling the magnetic induction head 41 to verify the authenticity of the inserted banknote. The press block 33 is made of nylon or any of a variety of light mass materials. Small push force from the inserted banknote causes the press block 33 to displace vertically.

As indicated above, the banknote receiving system has advantages as follows:

1. The springy suspension arm 322 imparts a spring force to the press block 33 to press the inserted banknote on the magnetic induction head 41 for verification positively.

2. The structure of the press device 32 is simple, saving much manufacturing and installation cost of the banknote receiving system.

3. Because the press block 33 is made of nylon, it does not interfere with the detection of the magnetic induction head 41.

A prototype of banknote receiving system has been constructed with the features of the annexed drawings of FIGS. 1˜5. The banknote receiving system functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A banknote receiving system comprising a housing, said housing having a banknote insertion slot, and a detector unit installed in said housing and adapted to verify the authenticity of banknote being inserted into said banknote insertion slot, wherein said detector unit comprises a first casing, and a second casing defining with said first casing a banknote passage for guiding inserted banknote from said banknote insertion slot to a banknote storage cabinet, said second casing comprising a magnetic induction head suspended at one side of said banknote passage and adapted to verify the authenticity of banknote passing through said banknote passage, said first casing comprising a press device adapted to press banknote passing through said banknote passage on said magnetic induction head, said press device comprising a mounting base, a springy suspension arm projected from the periphery of said mounting base and terminating in a free end, and an impression block located on one side of said free end and partially protruded over an outside wall of said first casing into said banknote passage and adapted to press banknote passing through said banknote passage on said magnetic induction head for verification.

2. The banknote receiving system as claimed in claim 1, further comprising a banknote storage cabinet fastened to said housing and adapted to receive banknote passed through said banknote passage.

3. The banknote receiving system as claimed in claim 1, wherein said impression block has a smoothly arched surface portion exposed to the outside of said first casing and facing said magnetic induction head.

4. The banknote receiving system as claimed in claim 1, wherein said impression block is made of nylon.

5. The banknote receiving system as claimed in claim 1, wherein the free end of said springy suspension arm has a stop rod disposed at one side opposite to said impression block and adapted to limit the amount of vertical movement of said free end and said impression block.

6. The banknote receiving system as claimed in claim 1, wherein said first casing further comprises a locating shaft; said base of said press device has a locating hole fastened to said locating shaft.

7. The banknote receiving system as claimed in claim 1, wherein said first casing comprises a receptacle adapted to receive and guide vertical movement of said free end of said springy suspension arm and said impression block.

8. The banknote receiving system as claimed in claim 1, wherein said housing comprises a bottom receiving chamber adapted to receive said detection unit, said bottom receiving chamber having two rear retaining notches respectively located on a rear side of each of two opposite side panels thereof; said first casing comprises two retaining members bilaterally disposed near a rear side thereof and adapted to engage the retaining notches of said bottom receiving chamber of said housing.
